(19) United States
(12) Patent Application Publication
(10) Pub. No.: US 2003/0000188 A1
(43) Pub. Date: Jan. 2, 2003

(54) Triangular cell honeycomb structure

(76) Inventors: Takashi Harada, Nagoya-city , Aichi-prefecture (JP); Yukio Miyairi, Nagoya-city , Aichi-prefecture (JP)

Correspondence Address: Parkhurst & Wendel, Suite 210, 1421 Prince Street, Alexandria, VA, 22314-2805, US

(21) Appl. No.: 10/169,560

(22) PCT Filed: Jan. 11, 2001
(86) PCT No.: PCT/JP01/00077

(30) Foreign Application Priority Data
Jan. 13, 2000 (JP) 2000-5064

(51) Int. Cl. B01D 39/20

(52) U.S. Cl. 55/523; 422/177

(57) ABSTRACT

There is provided a honeycomb structure (10) which has a large number of through channels (15) which are partitioned by walls (14) and penetrate in the axial direction, the wall (14) of the through channel (15) having a filtering function, and is constructed so that one end is clogged at predetermined through channels (15), and the other end is clogged at the remaining through channels (15). The through channel (15) has a triangular cross-sectional shape, and the density of the through channel (15) is below 54.3 cells/cm². According to this honeycomb structure, a less thermal stress occurs during the use; durability such that no crack develops is ensured; and moreover the pressure loss of fluid is low.

### TECHNICAL FIELD

The present invention relates to a honeycomb structure used as a filter which collects and removes particulate matters exhausted in a heat engine such as an internal combustion engine or combustion equipment such as a boiler.

### BACKGROUND ART

Conventionally, as a method for collecting and removing particulate matters contained in a dust-containing fluid such as exhaust gas emitted from a diesel engine or the like, there is known the use of a honeycomb structure in which a wall of through channel has a filtering function, one end is clogged at predetermined through channels, and the other end is clogged at the remaining through channels.

In the case where such a honeycomb structure is used as a filter for collecting particulate matters in exhaust gas, it is necessary to perform regenerating treatment in which accumulating carbon particulates are burned and removed. At this time, a local increase in temperature is unavoidable, so that a high thermal stress is liable to occur, which poses a problem in that a crack is liable to develop.

As measures for reducing the thermal stress occurring in such a structural part, a method in which the structural part is divided into small segments is known. The use of a honeycomb structure for collecting particulates in exhaust gas has already been proposed in JP-A-6-241017, JP-A-8-28246, JP-A-7-54643, JP-A-8-28248, etc.

However, even in the examples proposed in the aforementioned patent publications, the effect of reducing stress on segment surface is insufficient, and the problem of crack development cannot be solved completely.

Also, as other measures for reducing thermal stress, there has been proposed a method in which a portion liable to have a relatively low temperature is heated electrically by providing an electric heater between the segments to make the temperature distribution in honeycomb structure uniform. However, this method has a problem of the occurrence of a new thermal stress because a local temperature gradient rather increases in the vicinity of the electric heater.

Further, since a wall is used as a filter, the pressure loss of fluid is excessive, which poses a problem in that the engine performance is deteriorated.

The present invention has been made to solve the above problems, and accordingly an object thereof is to provide a honeycomb structure in which a less thermal stress occurs during the use; durability such that no crack develops is ensured and the pressure loss of fluid is low.

### DISCLOSURE OF THE INVENTION

According to the present invention, there is provided a triangular-cell honeycomb structure which has a large number of through channels which are partitioned by walls and penetrate in the axial direction, the wall of the through channel having a filtering function, and is constructed so that one end is clogged at predetermined through channels, and the other end is clogged at the remaining through channels, characterized in that the through channel has a triangular cross-sectional shape, and the density of the through channel is below 54.3 cells/cm².

In the present invention, it is preferable that the honeycomb structure have a circular, elliptical, racetrack-like, or polygonal cross-sectional shape, and have an outer peripheral face parallel with the flow path direction; the honeycomb structure have a construction in which honeycomb segments including the outer peripheral face of a shape such that the cross-sectional shape is divided into an integer of n by a plane parallel with the flow path direction are combined via joint layers; and the cell shape of each of the honeycomb segments be triangular, and the angle of one corner of the triangle coincide substantially with 1/m (m is an integer) of the angle that the faces in contact with the joint layers of each of the honeycomb segments make.

Also, in the honeycomb structure in accordance with the present invention, the honeycomb structure is preferably constructed so that honeycomb segments of a shape such that a cylindrical shape is divided into substantially six equal parts by a plane parallel with the flow path direction are combined into a cylindrical shape via the joint layers, and the thickness of the wall is preferably 0.32 mm or smaller.

Further, in the honeycomb structure in accordance with the present invention, a cell density is preferably not lower than 15.5 cells/cm² and lower than 54.3 cells/cm², and the Young's modulus of material of the joint layer is preferably 20% or less of the Young's modulus of material of the honeycomb segment.

In the present invention, a portion having an area of at least 30% of the surface area of the honeycomb segment in contact with the joint layer preferably has average surface roughness Ra exceeding 0.4 micron, and the ratio of the total heat capacity of all the joint layers in the honeycomb structure to the total heat capacity of all the honeycomb segments constituting the honeycomb structure is preferably 30% or lower.

Further, in the honeycomb structure in accordance with the present invention, it is preferable that a corner portion of a cross-sectional shape of the honeycomb segment in the cross section perpendicular to the through channel of the honeycomb structure be rounded with a radius of curvature of 0.3 mm or larger, or be chamfered 0.5 mm or more.

Also, the ratio of the total cross-sectional area of the joint layers to the cross-sectional area of the honeycomb structure in the cross section perpendicular to the through channel of the honeycomb structure is preferably 15% or lower, and further the ratio of the sum of the cross-sectional areas of the joint layers to the sum of the cross-sectional areas of the walls in the cross section of honeycomb structure perpendicular to the through channel of the honeycomb structure is preferably 50% or lower. Sill further, it is preferable that the ratio of the cross-sectional area of joint layer to the cross-sectional area of wall in the cross section of honeycomb structure perpendicular to the through channel of the honeycomb structure be higher in the central portion and be lower on the outer peripheral side.

As a material of the honeycomb segment, one kind of material selected from a group consisting of cordierite, SiC, SiN, alumina, mullite, and lithium aluminum silicate (LAS) is preferably used as a main crystal phase from the viewpoint of strength, heat resistance, and the like.

Also, it is preferable that the honeycomb segment carry a metal having a catalytic function so as to be used to purify exhaust gas from a heat engine or combustion equipment or to reform a liquid fuel or a gas fuel. As the metal having a catalytic function, at least one kind of Pt, Pd, and Rh is preferably used.

### BRIEF DESCRIPTION OF THE DRAWINGS

FIGS. 1(a), 1(b) and 1(c) are views showing one embodiment of a honeycomb structure in accordance with the present invention, FIG. 1(a) being a front view, and FIGS. 1(b) and 1(c) being partially enlarged views of FIG. 1(a).

FIGS. 2(a), 2(b) and 2(c) are views showing one embodiment of a honeycomb structure in accordance with the present invention, FIG. 2(a) being a front view, FIG. 2(b) being a side view, and FIG. 2(c) being a partially enlarged view of FIG. 2(a).

FIG. 3 is a sectional view for illustrating one example of a honeycomb structure.

FIG. 4 is a partially enlarged view showing a cell construction and a joint layer of a honeycomb structure.

### BEST MODE FOR CARRYING OUT THE INVENTION

The present invention will now be described in further detail with reference to an embodiment. The present invention is not limited to this embodiment.

The present invention relates to a honeycomb structure which has a large number of through channels which are partitioned by walls and penetrate in the axial direction, the wall of the flow having a filtering function, and is constructed so that one end is clogged at predetermined through channels, and the other end is clogged at the remaining through channels, and is characterized in that the through channel has a triangular cross-sectional shape, and moreover the density of through channel is below 54.3 cells/cm².

One feature of the honeycomb structure in accordance with the present invention is that the through channel has a triangular cross-sectional shape. The inventor carried out various studies, and resultantly found that in the honeycomb structure having the above-described construction, a triangular cell is suitable for decreasing the flow pressure loss of fluid.

Conventionally, a settled view has been that in the honeycomb structure having no closure on the end face, the pressure loss of fluid in a flow path relates to the hydraulic diameter of a cross-sectional shape of through channel, and since the pressure loss increases as the hydraulic diameter decreases, a triangular cell shape provides a higher pressure loss than a quadrangular, hexagonal or more polygonal, or circular cell shape.

On the other hand, in the case where the construction is such that one end is clogged for predetermined through channels, and the other end is clogged for the remaining through channels, and a wall is used as a filter as in the present invention, in addition to the flow pressure loss in the flow path, flow resistance is produced when the fluid passes through the wall, so that the relationship between the pressure loss and the through channel shape (cell shape) is complicated.

The inventor carried out studies on this respect earnestly, and resultantly found that in the comparison under the condition of the same opening area or the same cell density, the triangular shape has a larger filtration area than the quadrangular or more polygonal cell shape, and accordingly the velocity of fluid passing through the wall can be kept low, and the flow resistance when the fluid passes through the wall is kept low; however, in a region in which the through channel density (cell density) is high and the cross-sectional area of through channel is small, the ratio of the flow resistance in the flow path to the flow resistance of fluid passing through the wall increases, so that the triangular shape has a higher total pressure loss.

Further, as the result of advanced studies, the inventor found that in the case where the through channel density (cell density) is lower than 54.3 cells/cm² (350 cells/in²), the triangular cell having low flow resistance of fluid passing through the wall produces a lower total pressure loss than the quadrangular or more polygonal shape, and reached the present invention.

Also, if the cell density of honeycomb structure is lower than 15.5 cells/cm² (100 cells/in²), the filtration area is insufficient and the pressure loss is high. Therefore, the cell density is preferably 15.5 cells/cm² or higher.

Also, in the present invention, it is preferable that the honeycomb structure have a circular, elliptical, racetrack-like, or polygonal cross-sectional shape, and have an outer peripheral face parallel with the flow path direction; the honeycomb structure have a construction in which honeycomb segments including the outer peripheral face of a shape such that the cross-sectional shape is divided into an integer of n by a plane parallel with the flow path direction are combined via joint layers; and the cell shape of each of the honeycomb segments be triangular, and the angle of one corner of the triangle coincide with 1/m (m is an integer) of the angle that the faces in contact with the joint layers of each of the honeycomb segments make.

By this configuration, in the vicinity of an external wall in contact with the joint layer of honeycomb segment, a cell wall parallel with the honeycomb segment external wall can be arranged. Therefore, stress concentration in a joint portion of the honeycomb segment external wall and the wall can be prevented.

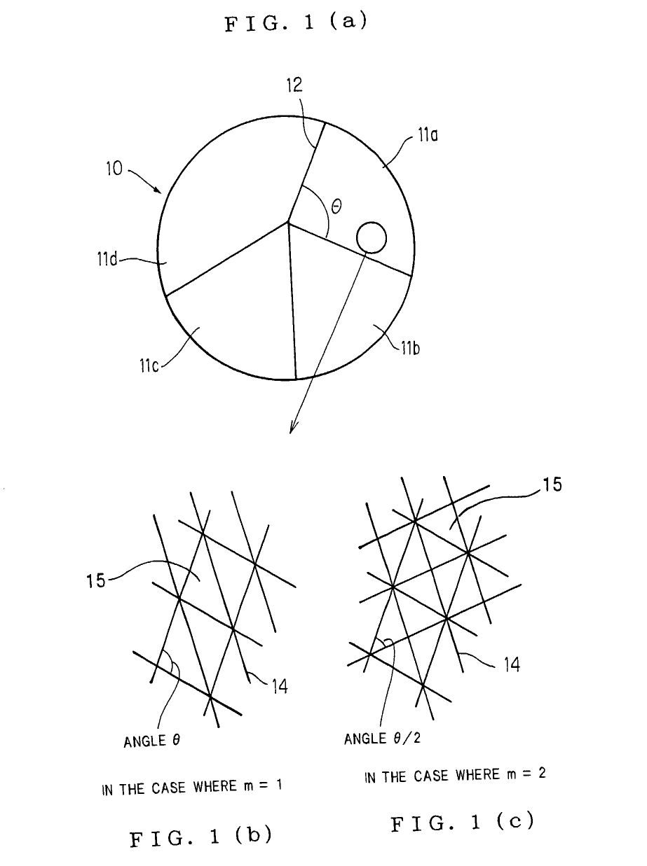

The above-described configuration will be explained with reference to the drawings. FIGS. 1(a), 1(b) and 1(c) are views showing one embodiment of a honeycomb structure in accordance with the present invention, FIG. 1(a) being a front view, and FIGS. 1(b) and 1(c) being partially enlarged views of FIG. 1(a).

As seen from FIG. 1(a), a honeycomb structure 10 has a circular cross-sectional shape and has an outer peripheral face parallel with the flow path direction. This honeycomb structure 10 has a construction in which honeycomb segments 11a, 11b, 11c and 11d including the outer peripheral face of a shape such that the cross-sectional shape is divided into four by a plane parallel with the flow path direction are combined via joint layers 12.

It is preferable that, as shown in FIGS. 1(b) and 1(c), the cell shape of each of the honeycomb segments 11a, 11b, 11c and 11d be triangular, and the angle θ of one corner of the triangle coincide substantially with 1/m of the angle Θ that the faces in contact with the joint layers 12 of each of the honeycomb segments 11a, 11b, 11c and 11d make. Herein, m is an integer, preferably m=1 to 4.

FIG. 1(b) shows the case where m=1, and FIG. 1(c) shows the case where m=2. In the figures, reference numeral 14 denotes the wall, and 15 denotes the through channel.

Further, it is further preferable that the honeycomb structure in accordance with the present invention be constructed so that honeycomb segments of a shape such that a cylindrical shape is divided into substantially six equal parts by a plane parallel with the flow path direction are combined into a cylindrical shape via the joint layers. The reason for this is as described below.

By the above-described construction, the radial wall and the external wall in contact with the joint portion of honeycomb segment can be set in parallel, so that stress concentration in the joint portion of the segment external wall and the wall can be prevented.

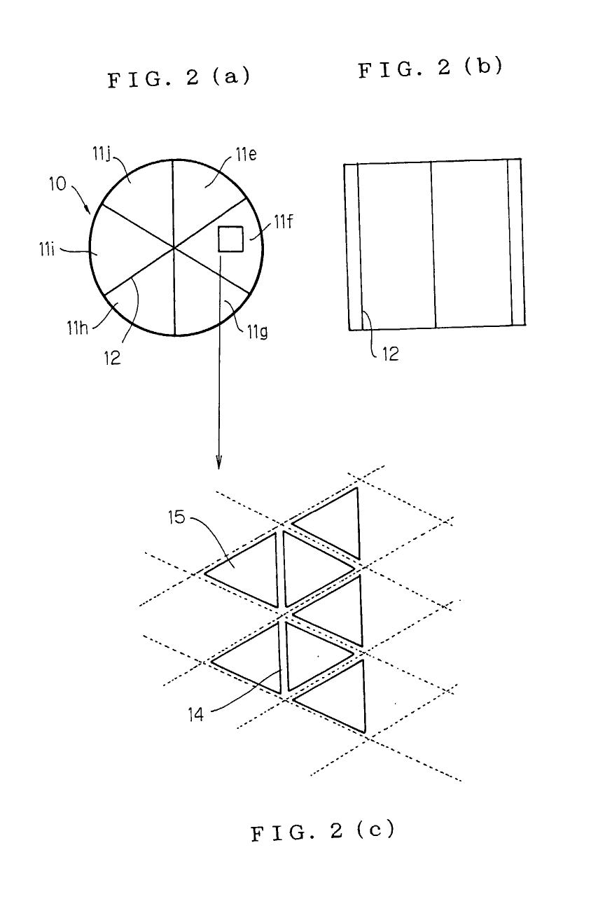

This construction will be explained with reference to the drawings. FIGS. 2(a), 2(b) and 2(c) are views showing one embodiment of the above-described honeycomb structure in accordance with the present invention, FIG. 2(a) being a front view, FIG. 2(b) being a side view, and FIG. 2(c) being a partially enlarged view of FIG. 2(a).

The honeycomb structure 10 is constructed so that honeycomb segments 11e, 11f, 11g, 11h, 11i and 11j of a shape such that a cylindrical shape is divided into substantially six equal parts by a plane parallel with the flow path direction are combined into a cylindrical shape via the joint layers 12. The cell shape of each of the honeycomb segments 11e, 11f, 11g, 11h, 11i and 11j is triangular, and the angle θ of one corner of the triangle coincides with 1/m (m=1) of the angle Θ that the faces in contact with the joint layers 12 of each of the honeycomb segments 11e, 11f, 11g, 11h, 11i and 11j make.

Also, since the outer peripheral face (external shape) formed by combining the honeycomb segments as the honeycomb structure is of a cylindrical shape as described above, a holding force from the outer periphery can be transmitted uniformly to the inside. Also, by a synergetic effect obtained by the fact that the triangular cell has lower isotropy of force transmission than the quadrangular cell, uneven distribution of local stresses can be prevented.

In the honeycomb structure in accordance with the present invention, the thickness of wall is preferably 0.32 mm or smaller, further preferably in the range of 0.20 to 0.30 mm from the viewpoint of reduction in the flow resistance of fluid passing through the cell wall.

Also, in the honeycomb structure in accordance with the present invention, the Young's modulus of a material forming the joint layer is preferably 20% or less, more preferably 1% or less, of the Young's modulus of a material forming the honeycomb segment. By specifying the materials of the joint layer and the honeycomb segment, a honeycomb structure in which a less thermal stress occurs during the use, and durability such that no crack develops is ensured can be provided.

Also, it is preferable that in this honeycomb structure, a portion having an area of at least 30% of the surface area of the honeycomb segment in contact with the joint layer have average surface roughness Ra exceeding 0.4 micron. Thereby, the honeycomb segments are joined more firmly, and a fear of peeling off at the time of use can almost be dispelled. The aforementioned surface roughness Ra is further preferably be 0.8 microns or more.

Further, the ratio of the total heat capacity of all the joint layers in the honeycomb structure to the total heat capacity of all the honeycomb segments constituting the honeycomb structure is made 30% or lower, preferably 15% or lower, by which a thermal stress occurring during the use is desirably made less, and durability such that no crack develops in the honeycomb structure is desirably ensured.

Further, it is preferable that in the honeycomb structure in accordance with the present invention, a corner portion of a cross-sectional shape of honeycomb segment in the cross section perpendicular to the through channel of honeycomb structure be rounded with a radius of curvature of 0.3 mm or larger, or be chamfered 0.5 mm or more because the occurrence of thermal stress at the time of use is reduced and great durability such that no crack develops can be given to the honeycomb structure.

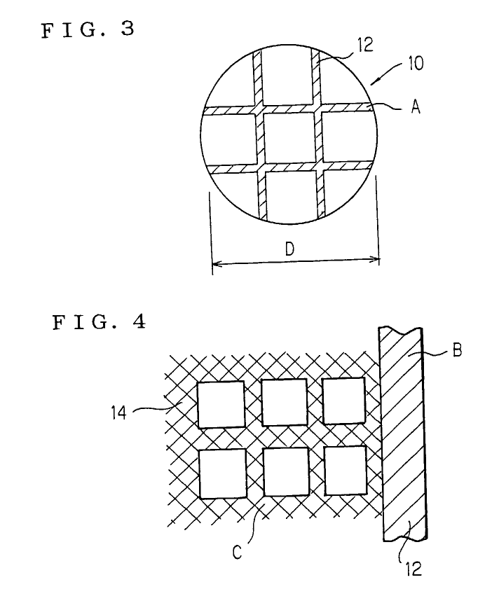

Further, in the present invention, it is preferable that the ratio of the total cross-sectional area of the joint layers to the cross-sectional area of the honeycomb structure in the cross section perpendicular to the through channel of honeycomb structure be 17% or lower, more preferably 8% or lower. The explanation of this is given with reference to FIG. 3. Referring to FIG. 3, in the circular honeycomb structure 10 having a cross section with diameter D, the total cross-sectional area S_{H} of the honeycomb structure 10 is expressed by the following formula.

S_{H}=(π/4)×D²

On the other hand, the total cross-sectional area S_{S} of the joint layers 12 is the total area of hatched portion A in FIG. 3 (cross-sectional portion of the joint layers 12).

Herein, the ratio of S_{S}/S_{H} should preferably be 17% or lower from the viewpoint of the decrease in pressure loss of fluid.

Further, in the present invention, it is preferable that the ratio of the sum of the cross-sectional areas of joint layers to the sum of the cross-sectional areas of walls in the cross section of honeycomb structure perpendicular to the through channel of honeycomb structure be 50% or lower, more preferably 24% or lower. Referring to FIG. 4, taking the sum of the cross-sectional areas (hatched portion B) of the joint layers 12 in the cross section of the honeycomb structure 10 as S_{S}, and taking the sum of the cross-sectional areas (meshed portion C) of the walls 14 as S_{C}, the ratio of S_{S}/S_{C} should preferably be 50% or lower from the viewpoint of the decrease in pressure loss of fluid.

Further, in the present invention, it is preferable that the ratio of the cross-sectional area of joint layer to the cross-sectional area of wall in the cross section of honeycomb structure perpendicular to the through channel of honeycomb structure be higher in the central portion and be lower on the outer peripheral side. Because of the joint layers closer to each other at the center and more apart from each other at the periphery, the quantity of collected carbon particulates per unit volume is smaller in the vicinity of the center than in the vicinity of the outer periphery, so that at the time of regenerating treatment at which carbon particulates are burned (regenerative combustion time), the calorific value in the vicinity of the center, where high temperatures are liable to be generated, can be kept low. Moreover, the joint layer in the vicinity of the center is dense, so that the heat capacity in that portion can be increased. For these reasons, the increase in temperature in the vicinity of the center can be kept low. As a result, a difference in temperature between the central portion and the outer peripheral side can be decreased, so that the thermal stress in the honeycomb structure can desirably be decreased.

Also, the honeycomb segment constituting the honeycomb structure in accordance with the present invention preferably has a main crystal phase of one kind selected from a group consisting of cordierite, SiC, SiN, alumina, mullite, and lithium aluminum silicate (LAS) from the viewpoint of strength, heat resistance, and the like. Silicon carbide (SiC), which has a high coefficient of thermal conductivity, is especially preferable because heat can be dissipated easily.

As a material of joint layer that joins the honeycomb segment to each other, ceramic fiber, ceramic powder, cement, or the like, which has heat resistance, are preferably used singly or by being mixed. Further, as necessary, an organic binder, an inorganic binder, etc. may be used by being mixed. The material of joint layer is not limited to the above-described materials.

The honeycomb structure in accordance with the present invention has a construction such that, as described above, it has a large number of through channels which are partitioned by walls and penetrate in the axial direction; the wall of the through channel has a filtering function; and one end is clogged at predetermined through channels, and the other end is clogged at the remaining through channels. Therefore, the honeycomb structure can be suitably used as a filter which collects and removes particulate matters contained in a dust-containing fluid, such as a particulate filter for a diesel engine.

Specifically, if a dust-containing fluid is caused to pass through one end face of the honeycomb structure having such a construction, the dust-containing fluid enters a through channel in the honeycomb structure whose end on the one end face side is not clogged, and passes through the porous wall having a filtering function to enter another through channel in the honeycomb structure whose end on the other end face side is not clogged. When passing through the wall, particulate matters in the dust-containing fluid are collected to the wall, and the purified fluid from which particulate matters have been removed is discharged from the other end face of honeycomb structure.

If the collected particulate matters accumulate on the wall, the wall is clogged, so that the function as a filter decreases. Therefore, the honeycomb structure is heated periodically by heating means such as a heater to burn and remove the particulate matters, by which the filtering function is regenerated. To accelerate the combustion of particulate matters at the time of regeneration, a metal having a catalytic function, as described later, may be carried on the honeycomb segment.

On the other hand, in the case where the honeycomb structure in accordance with the present invention is used to purify exhaust gas from a heat engine such as an internal combustion engine or to reform a liquid fuel or a gas fuel as a catalyst carrier, a metal having a catalytic function is carried on the honeycomb segment. As a typical metal having a catalytic function, Pt, Pd, and Rh are cited. At least one kind of these metals is preferably carried on the honeycomb segment.

Hereunder, the present invention will be described in further detail with reference to examples. The present invention is not limited to these examples.

### EXAMPLE

A honeycomb structure measuring 144 mm in diameter and 153 mm in length having a construction such that the honeycomb segments 11e, 11f, 11g, 11h, 11i and 11j of a shape such that a cylindrical shape is divided into six equal parts by a plane parallel with the flow path direction are combined into a cylindrical shape via the joint layers 12 as shown in FIGS. 2(a), 2(b) and 2(c) was manufactured using a SiC-made honeycomb segment having a wall thickness of 0.300 mm, a cell density of 240 cells/in² (37.2 cells/cm²), and a thickness of outer peripheral portion of 0.5 mm, and using a mixture of ceramic fiber, ceramic powder, and organic and inorganic binders as the joint layer. The properties of the obtained honeycomb structure are given in Table 1. Also, the surface roughness given in Table 1 indicates the average surface roughness of the whole surface of honeycomb segment in contact with the joint layer.

This honeycomb structure is a particulate filter for purifying exhaust gas from a diesel engine, which has a construction such that one end is clogged at predetermined through channels, and the other end is clogged at the remaining through channels. The fluid pressure loss test and the regeneration test were conducted on these honeycomb structures. The results are given in Table 1.

TABLE 1

| | |
|---|---|
| Young's modulus of wall material | 42 |
| (Gpa) | |
| Young's modulus of joint layer material | 8 |
| (Gpa) | |
| Young's modulus of joint layer/Young's | 19 |
| modulus of wall (%) | |
| Segment corner | R0.3 |
| Result of regeneration test | Good, no crack |
| Segment surface roughness (Ra μm) | 0.8 |
| Axial shift after test | No |
| Wall thickness (mm) | 0.3 |
| Joint layer thickness (mm) | 2 |
| Joint layer area/structure area (%) | 5.3 |
| Joint layer area/wall area (%) | 12.5 |
| Result of fluid pressure loss test | Allowable range |
| Regeneration time | Allowable range |
| Heat capacity ratio (%) | 7.5 |

[Evaluation]

As is apparent from the results given in Table 1, when the requirements specified in the present invention were satisfied, the pressure loss of fluid was not so high, being within the allowable range (10 kPa), and the regeneration time was within the allowable range (15 min).

Industrial Applicability

As described above, the honeycomb structure in accordance with the present invention achieves a remarkable effect that a less thermal stress occurs during the use; durability such that no crack develops is ensured; and moreover the pressure loss of fluid is low. Therefore, the honeycomb structure in accordance with the present invention can be used suitably as a filter which collects and removes particulate matters exhausted in a heat engine such as an internal combustion engine or combustion equipment such as a boiler.

1. A triangular-cell honeycomb structure which has a large number of through channels which are partitioned by walls and penetrate in axial directions, the wall of said through channel having a filtering function, and is constructed so that one end is clogged at predetermined through channels, and the other end is clogged at the remaining through channels, characterized in that
said through channel has a triangular cross-sectional shape, and the density of said through channel is below 54.3 cells/cm².

2. The honeycomb structure according to claim 1, characterized in that said honeycomb structure has a circular, elliptical, racetrack-like, or polygonal cross-sectional shape, and has an outer peripheral face parallel with the flow path direction; said honeycomb structure has a construction in which honeycomb segments including the outer peripheral face of a shape such that the cross-sectional shape is divided into an integer of n by a plane parallel with the flow path direction are combined via joint layers; and the cell shape of each of said honeycomb segments is triangular, and the angle of one corner of the triangle coincides substantially with 1/m (m is an integer) of the angle that the faces in contact with said joint layers of each of said honeycomb segments make.

3. The honeycomb structure according to claim 1, characterized in that said honeycomb structure is constructed so that honeycomb segments of a shape such that a cylindrical shape is divided into substantially six equal parts by a plane parallel with the flow path direction are combined into a cylindrical shape via said joint layers.

4. The honeycomb structure according to any one of claims 1 to 3, characterized in that the thickness of said wall is 0.32 mm or smaller.

5. The honeycomb structure according to any one of claims 1 to 4, characterized in that a cell density is from 15.5 cells/cm² or more to below 54.3 cells/cm².

6. The honeycomb structure according to any one of claims 1 to 5, characterized in that the Young's modulus of material of said joint layer is 20% or less of the Young's modulus of material of said honeycomb segment.

7. The honeycomb structure according to any one of claims 1 to 6, characterized in that a portion having an area of at least 30% of the surface area of said honeycomb segment in contact with said joint layer has an average surface roughness Ra exceeding 0.4 micron.

8. The honeycomb structure according to any one of claims 1 to 7, characterized in that the ratio of the total heat capacity of all the joint layers in said honeycomb structure to the total heat capacity of all the honeycomb segments constituting said honeycomb structure is 30% or lower.

9. The honeycomb structure according to any one of claims 1 to 8, characterized in that a corner portion of the cross-sectional shape of said honeycomb segment in a cross section perpendicular to the through channel of said honeycomb structure is rounded with a radius of curvature of 0.3 mm or larger, or is chamfered 0.5 mm or more.

10. The honeycomb structure according to any one of claims 1 to 9, characterized in that the ratio of the total cross-sectional area of said joint layers to the cross-sectional area of said honeycomb structure in a cross section perpendicular to the through channel of said honeycomb structure is 15% or lower.

11. The honeycomb structure according to any one of claims 1 to 10, characterized in that the ratio of the sum of the cross-sectional areas of said joint layers to the sum of the cross-sectional areas of said walls in a cross section of honeycomb structure perpendicular to the through channel of said honeycomb structure is 50% or lower.

12. The honeycomb structure according to any one of claims 1 to 11, characterized in that the ratio of the cross-sectional area of said joint layer to the cross-sectional area of said wall in the cross section of honeycomb structure perpendicular to the through channel of said honeycomb structure is higher in the central portion and is lower on the outer peripheral side.

13. The honeycomb structure according to any one of claims 1 to 12, characterized in that said honeycomb segment has a main crystal phase of one kind selected from a group consisting of cordierite, SiC, SiN, alumina, mullite, and lithium aluminum silicate (LAS).

14. The honeycomb structure according to any one of claims 1 to 13, characterized in that said honeycomb segment carries a metal having a catalytic function so as to be used to purify exhaust gas from a heat engine or combustion equipment or to reform a liquid fuel or a gas fuel.

15. The honeycomb structure according to claim 14 characterized in that said metal having a catalytic function is at least one kind of Pt, Pd, and Rh.
